(19) United States
(12) Patent Application Publication
(10) Pub. No.: US 2026/0159445 A1
(43) Pub. Date: Jun. 11, 2026

(54) PREPARATION METHOD

(71) Applicant: OLIMENT® GmbH, Rötha OT Espenhain (DE)

(72) Inventor: Günter BELLMANN, Leipzig (DE)

(73) Assignee: OLIMENT® GmbH, Rötha OT Espenhain (DE)

(21) Appl. No.: 18/725,196

(22) PCT Filed: Jan. 12, 2022
(86) PCT No.: PCT/EP2022/050561

§ 371 Date: Jun. 28, 2024

(51) Int. Cl. C04B 9/20

(52) U.S. Cl. CPC C04B 9/20

(57) ABSTRACT

The invention relates to a method for preparing a starting product for producing of a building material, wherein the starting product is crushed and homogenized before it is fed to a further treatment. According to the invention, the crushing and homogenizing is realized in the context of wet grinding, wherein a product is selected as starting product which comprises at least 20 percent by mass of one or more of the following components, ultramafic rocks, weathering products of ultramafic rocks or a forsterite source. Furthermore, the invention also relates to a prefabricated building component which is produced using the method according to the invention.

The invention relates to a method for preparing a starting product for producing a building material.

In the generic method, the starting product is crushed and homogenized before it is fed for further treatment.

The grinding of cements in ball mills and other units is an energy-intensive process. The electrical energy requirement is around 50 kWh/t and depends, in particular on the desired grinding fineness. A large proportion of the electrical energy is not converted into crushing work, but is lost as heat.

One reason for the low efficiency of the grinding process is agglomeration of the cement particles in the mill. This agglomeration can be reduced by adding organic liquids referred to as grinding aids. When using these grinding aids, the amount of electrical energy required to achieve the same fineness can be reduced. However, the production of grinding aids is associated with negative environmental impacts and the use of these substances represents an additional cost factor in cement production.

Another way to improve the electrical energy requirements of grinding is to use more efficient mills, such as vertical roller mills and similar units.

Even with the use of grinding aids, the application of more efficient types of mills and other measures, the energy required for cement grinding remains high.

The object underlying the invention is therefore that of providing a preparation method which can be carried out in an energy-efficient manner, as well as a prefabricated building component which can be manufactured in a more energy-efficient manner using the method.

According to the invention, this object is achieved by a method for preparing a starting product for producing a building material having the features of claim 1 as well as by a prefabricated building component having the features of claim 15.

Further advantageous embodiments are specified in the dependent claims and the further description.

According to claim 1, it is provided that in the method according to the invention the crushing and homogenizing is carried out in the context of wet grinding. Furthermore, a starting product is selected which comprises at least 20 percent by mass, preferably at least 40 percent by mass, more preferably at least 60 percent by mass, even more preferably at least 80 percent by mass, of one or more of the following components: ultramafic rocks, in particular dunite, weathering products of ultramafic rocks, in particular serpentinite, a source of forsterite in the form of a natural or artificial source of olivine.

A basic idea of the invention can be seen in replacing the previously known dry grinding with wet grinding. This means that the material to be ground is mixed with a liquid, in particular water, and ground as a suspension.

When grinding in suspension form, only marginal particle agglomeration occurs and the water also acts as a coolant. This significantly reduces the energy required for grinding. Another advantage resides in that the raw materials do not need to be dried before grinding, by which again saves energy.

Furthermore, the addition of organic grinding aids can be dispensed with, so that grinding is more environmentally friendly and additional costs can be saved.

It has also been shown that a higher fineness can be achieved with wet grinding than with dry grinding for the same energy input.

The problem here is that conventional cements containing Portland cement clinker, for example, cannot be used as this reacts with water already at room temperature. This would result in cement hydrating in the mill already during the grinding process, so making wet grinding counterproductive.

In accordance with the invention, it was therefore recognized that other starting products must be used to produce binders that do not hydrate at room temperature. This makes it possible to achieve the advantage of lower energy consumption during grinding.

Therefore, according to the invention, it is intended to use MgO-based cements which do not set at room temperature. According to the invention, ultramafic rocks, in particular dunite, weathering products of ultramafic rocks, in particular serpentinite, and/or a forsterite source in the form of a natural or artificial olivine source, as well as combinations thereof, can be used as sources for this.

An important mineral in ultramafic rocks is olivine. This is a mixed crystal series between fayalite (Fe₂SiO₄), forsterite (Mg₂SiO₄), tephroite (Mn₂SiO₄) and other minerals of the formula A₂[SiO₄]. Natural olivine deposits are documented and the olivine is often a magnesium-rich material with iron contents.

Forsterite reacts with water to antigorite (3 MgO·2SiO₂·2H₂O, Mg₃Si₂O₅(OH)₄) or other crystalline or X-ray amorphous magnesium silicate hydrates. However, this reaction only takes place at temperatures well above room temperature. However, it can be accelerated by elevated temperatures so that this conversion can be used to produce building materials.

The underlying reaction can be described as follows:

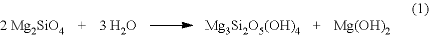

The reactions described occur in particular then when no SiO₂ source is present. However, if a natural source of forsterite is used, an associated SiO₂ source is often also present. However, this is not detrimental to the invention.

Forsterite reacts with SiO₂ and water to magnesium silicate hydrate (M-S—H). This reaction also only takes place at a relevant rate at temperatures well above room temperature. SiO₂ can be explicitly added to the starting product by SiO₂ sources and/or be present as a by-product of the forsterite source. However, if a natural forsterite source is used, it often contains at least a small amount of SiO₂, as already described. The underlying reaction can be described as follows:

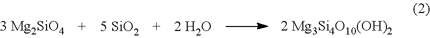

Consequently, forsterite reacts with SiO₂ and water to magnesium silicate hydrate.

In other words, during the thermal treatment of the homogenized starting product, it is at least partially converted into magnesium hydroxide (Mg(OH)₂) and magnesium silicate hydrates (Mg₃Si₂O₅(OH)₄, Mg₃Si₄O₁₀(OH)₂) by the presence of H₂O. The underlying reactions are given in (1) and (2), wherein these are given here in simplified form starting from forsterite (Mg₂SiO₄):

Here, reaction (1) is the primary reaction. As explained in more detail later, Mg₃Si₂O₅(OH)₄ is better suited to binding CO₂ than Mg₃Si₄O₁₀(OH)₂. It should also be noted that the quantity of the respective products and their ratio depends, among other things, on the exact composition of the starting product.

The magnesium hydroxide (Mg(OH)₂) can be present here as brucite. The magnesium silicate hydrate (Mg₃Si₂O₅(OH)₄, Mg₃Si₄O₁₀(OH)₂) can be present in the form of lizardite, antigorite, talc and other forms. In this context, it should be noted that the stoichiometric water content is sometimes lower—in the range of 13 percent by mass for antigorite—than that determined by tests—in the range of 16 percent by mass to 20 percent by mass. This can be explained by the fact that some of the materials are so fine that water can also adhere to their surface.

Similarly, such deviations from the stoichiometry also apply to the ratio between Mg and Si. Furthermore, foreign ions, such as Fe, can also be incorporated into the reaction products. However, other reaction products such as hydromagnesite, hematite, magnetite or gibbsite can also be formed. This depends in each case on the exact composition of the starting product. All or some of the reaction products may contain iron, carbonate and alkalis or other foreign ions.

It is preferable if the starting product is mixed with a liquid, in particular water, and ground as a suspension. It has been found that grinding as a suspension is very energy-saving, as only marginal particle agglomeration occurs and the liquid can already act as a coolant. This reduces the energy required for grinding.

In principle, the suspension can be conveyed further from the grinding unit as required.

It is advantageous if it is fed to further treatment with the crushed and homogenized feed product by means of hydraulic transport. This may involve pumps, for example. This enables relatively simple transportation to and from the grinding unit.

By choosing a starting product that does not hydrate at room temperature, it is advantageous to treat it further for hydration. For this purpose, the crushed, homogenized starting product can be treated in a heat treatment apparatus at a temperature of over 30° C. for at least 2 hours, wherein water is added to the starting product before and after or simultaneously with the crushing and homogenization and this is mixed with the starting product and/or steam is introduced into the heat treatment apparatus. In particular when processing the starting product as a suspension, it is not absolutely necessary to add more water.

By treating the starting product in a heat treatment apparatus at temperatures more than 30° C., in particular more than 80° C., the reactions described above are accelerated so that a solidified building material, in particular a prefabricated building component, can be produced which can be used in a similar way to known concrete blocks or molded concrete elements. A higher temperature generally accelerates the sequence of the necessary reactions. It is also possible, for example, to produce tiles that can be used to clad buildings or the like. The important thing here is that a solid building material can be produced that can be shaped as desired and can therefore also be used for different purposes.

At least when using tempered serpentinite in the starting product, but preferably also when using a natural or artificial olivine source, the starting product should be free of alite and belite, as these can cause hardening problems. Similar problems can also occur in the presence of molybdenum ore, in particular in powder form. Therefore, a maximum of 12 percent by mass, preferably significantly less, a maximum of 5 percent by mass, should be present in the feed product. For the purposes of the invention, tempered serpentinite can be understood in particular as serpentinite which has been heated to a temperature of at least 500° C. Instead of the technical term “tempered”, the term “calcined” is often used. In principle, however, it is not absolutely necessary to temper the serpentinite.

Additional technical steps can be advantageous for certain compositions of source rocks as a starting product or to improve the binder properties. These include thermal treatment of the material. Such processes are also suitable for producing olivine in materials that previously contained no olivine, for example serpentinite. Another pre-treatment option is to mix different rocks. In addition to olivine, the rock often contains other mineral phases, including feldspars and other silicates.

The treatment can take place in a heat treatment apparatus at a temperature of over 100° C. for at least 24 hours. A heat treatment apparatus can be, for example, a heat tunnel or an autoclave. An autoclave is usually understood to be a gas-tight, sealable pressure vessel that can be used for the thermal treatment of substances in the overpressure range. It is preferable for the heat treatment apparatus to be understood as a vessel, a combination of devices, such as an oven and a sealed mold, or a device for enclosing a volume which prevents the crushed and homogenized starting product from drying out during heating. A loss of water, particularly a significant loss, would slow down or even stop the reaction described below, lead to reduced strength and should therefore be avoided. This can be achieved on the one hand by closing the volume, but on the other hand also, for example, by ensuring that sufficient moisture is present in the device or is supplied. For example, it is still in the spirit of the invention to heat the crushed and homogenized starting product in a special room in which it is ensured that the humidity is permanently high enough. This may even be a heating tunnel.

If the formworks used for the prefabricated building component is waterproof, the temperature treatment can even be carried out without an autoclave, as water loss through the formwork is prevented. It is advantageous if a water loss of more than 20%, in particular more than 10%, is prevented during the sequence of the chemical reactions described below. Subsequently, during further drying, after at least a large part of the reactions have been completed, a higher loss of water can occur, but this is then harmless.

The treatment is preferably carried out at temperatures above 100° C., in particular above 150° C. and even more preferably above 250° C. It is advantageous for good conversion if the treatment is carried out for longer than 36 hours, even more preferably longer than 48 hours. However, particularly good results can be achieved if the treatment is carried out even longer, for several days, for example 4, preferably 7 days or longer.

In order to accelerate the reactions described above, it is advantageous if the crushed homogenized starting product is treated at temperatures above 100° C. It has also been found to be energy efficient if this temperature is not or not significantly exceeded, so that the treatment can take place at below 120° C. However, the reaction is accelerated at higher temperatures, so that treatment at over 200° C., preferably at 250° C. and even better at over 300° C., is also possible.

In the context of the invention, the temperature specifications and the time specifications can also be regarded as an average temperature over a given period of time, so that, for example, treatment by means of temperature ramps is also possible. For example, the temperature can also be set to 80° for 1 hour and then to 120° for 2 hours, wherein a short cooling time between the temperature changes is in addition possible.

Particularly good results have been shown when the crushed and homogenized starting product is treated in the heat treatment apparatus at a temperature of over 150° C. and at a water vapor partial pressure of over 5 bar for over at least 12 hours. A starting product treated in this way results in a building material with high strength. Even a treatment of more than 12 hours, essentially independent of the selected temperatures and/or the selected pressures, produces a starting product with sufficient strength.

These parameters also represent a good compromise between the energy required and time required. It is of course also possible to carry out the process at a lower temperature over a longer period of time and vice versa. Here, individual parameters can also be varied separately.

In the case of products from reactions (1) and/or (2), the crushed and homogenized starting product can be subjected to dewatering of bound water by means of thermal treatment and/or reaction grinding after treatment in the heat treatment apparatus. During thermal treatment, the converted starting product can be treated at a temperature of between 180° C. and 1000° C. Alternatively or additionally, during reaction milling, a rearrangement of the crystal structure can occur in the converted starting product.

Bound water is also sometimes referred to as water of crystallization. It must be distinguished from unbound water, which can be regarded as free H₂O. Complete dewatering can be achieved at great expense. According to the invention, the water content of bound water should be reduced by at least 60%, preferably by at least 80%, even more preferably by at least 90%.

For thermal treatment, the converted starting product can be heated to a temperature between 180° C. and 1000° C. Depending on the fineness present, heating for just a few minutes is sufficient for this process. Temperatures between 300° C. and 800° C. are preferred, even more advantageously between 500° C. and 700° C. Alternatively or additionally, the converted starting product can also be subjected to reaction grinding to rearrange the crystal structures. In so-called reaction grinding, crystalline water can also be removed from the converted starting product by rearranging the crystal structures. For this purpose, additives such as quartz can be added to the grinding process.

In this step, dehydration converts magnesium hydroxide (Mg(OH)₂) present in the converted starting product at least partially into magnesium oxide (MgO) and magnesium silicate hydrate (Mg₃Si₂O₅(OH)₄, Mg₃Si₄O₁₀(OH)₂) being present at least partially into dehydrated magnesium silicate hydrate, which can be represented in simplified form as xMgO·SiO₂·yH₂O. Dehydration here refers to the reduction of crystalline water or water of crystallization in the converted starting product.

The here underlying chemical processes are, again simplified, as follows:

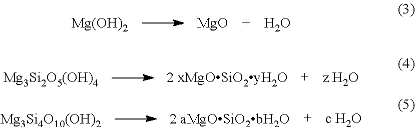

wherein (4) produces a largely amorphous reaction product with a Mg to Si ratio of 1.5 to 2 and a bound water content of around 3%. The reaction product formed in equation (5) has an even lower Mg to Si ratio. Hence the variables a, b, c, x, y and z. This depends, in each case on the exact composition of the starting product and the treatment parameters.

After dewatering, the water content of the bound water in the converted, dewatered starting product is preferably less than 10 percent by mass, more advantageously less than 5 percent by mass, even more preferably less than 3.5 percent by mass, still more preferably less than 2.5 percent by mass.

The transformed and dehydrated starting product is therefore present as a multiphase product. Other possible secondary phases are hematite, magnetite, enstatite, feldspars, pyroxenes, quartz and amorphous phases.

The thermal treatment proposed for this purpose can also be referred to as tempering or calcination. It can be carried out in a rotary kiln or by means of a circulating fluidized bed of hot gases. When using a fluidized bed, dewatering occurs within a few seconds. Alternatively, the necessary energy can also be applied electrically, for example in a muffle furnace. In this case, times of around 5 minutes to 10 minutes are required. In principle, open systems with flames, for example, are preferable, as here it is easier to remove the resulting water vapor, which speeds up the reaction.

The building material, in particular after reaction (1), can react with carbon dioxide in different ways after hardening. The reaction of brucite (Mg(OH)₂) with CO₂, which is particularly simple and rapid, is shown here as an example.

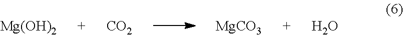

In addition to magnesite (MgCO₃), similar compounds can also be formed. Some of these contain water. Thus can lead to the fact that, during the use of a concrete component produced using the method according to the invention, carbon dioxide can slowly migrate from the atmosphere into the concrete. In this case, the carbon dioxide can be firmly bound as magnesium carbonate by a chemical reaction and is thus removed from a CO₂ source, for example the atmosphere.

It is further preferred if a CO₂ source and/or a carbonate source is present in the heat treatment apparatus or, if the crushed homogenized heat-treated starting product comes into contact with a CO₂ source after the heat treatment apparatus. In this preferred embodiment, it was recognized that the building material produced by the method according to the invention can also be used for CO₂ sequestration or that the presence of CO₂ or carbonates accelerates the course of the desired reaction. This applies in particular to the course of the reaction according to (1).

On the one hand, the presence of CO₂ can accelerate the hardening process of the building material. On the other hand, carbon dioxide can be bound in this way, so that a further reduction in this respect is possible. Another underlying reaction can be described as follows:

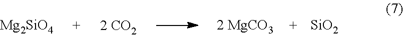

The absorption of carbon dioxide can be accelerated by setting higher CO₂ partial pressures and average air humidities. Alternatively or optionally, suitable CO₂ and/or carbonate sources such as Na₂CO₃ or K₂CO₃ can be added to the starting product during mixing or in the heat treatment apparatus, preferably in an autoclave. At the same time, the addition of Na₂CO₃ accelerates hardening.

Furthermore, the CO₂ reacts with the magnesium oxide (MgO) present, the dehydrated magnesium silicate hydrate (xMgO·SiO₂·yH₂O) present and/or the magnesium hydroxide (Mg(OH)₂) present. The CO₂ is mainly bound in the resulting magnesium carbonate (MgCO₃) and/or magnesium carbonate hydrate (MgCO₃·mH₂O).

The underlying chemical processes are shown simplified and generalized as follows:

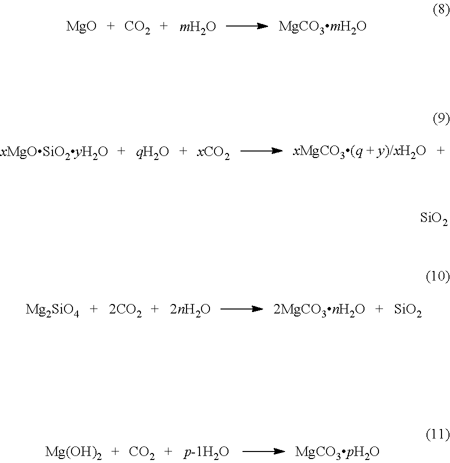

where m, n, p, q, x and y represent corresponding variables. Some of these can be zero. It should also be noted that in equation (9) the dehydrated magnesium silicate hydrate only appears as xMgO·SiO₂·yH₂O, as it has been (incompletely) dehydrated. Equation (10) shows forsterite (Mg₂SiO₄), which may still be present. Forsterite or olivine from the starting material may still be present at this point of time. It should also be noted that the xMgO·SiO₂·yH₂O is very similar to forsterite and can be regarded as amorphous forsterite for simplicity.

In principle, it is sufficient if the converted and dehydrated starting product is contacted with CO₂, as described above, for example in the air, so that it forms a bond with the CO₂. However, the binding process can be intensified and accelerated if the contacting of the converted, dehydrated starting product with CO₂ is carried out in an aqueous suspension by blowing in CO₂-containing gas such as air. It has been shown that this method step enables the CO₂ to be bound more quickly than if it is treated with normal ambient air alone in the absence of water.

The contacting of the converted, dehydrated starting product with a CO₂-containing gas can be carried out at partial pressures of at least 200 ppm, 400 ppm, 1000 ppm, 10,000 ppm, 100,000 ppm, 200,000 ppm, in particular already at room pressure or in the range of maximum 2 bar, which corresponds to 2 million ppm. According to the invention, it is not necessary to provide high pressures in order to achieve rapid and sufficient binding of the CO₂. However, the binding of the CO₂ is further accelerated by higher partial pressures.

If a starting product is provided which already contains at least 20 percent by mass magnesium silicate hydrate, preferably at least 40 percent by mass, more preferably at least 60 percent by mass, even more preferably at least 80 percent by mass, as is the case with serpentinite, for example, the steps of adding water and thermal treatment can be dispensed with, so that CO₂ can be bound directly after dewatering. Serpentinite is a metamorphic rock that is formed by natural transformation, in particular weathering, of ultramafic rocks.

Depending on the raw materials selected, the starting product may contain Fe in a reduced form such as Fe₂SiO₄. It is preferable if the formation of H₂ is reduced and/or the expansion of the H₂ is reduced, which leads to swelling. In order to minimize the formation, the forsterite source is fired with prior addition of correcting agents and/or an oxidizing agent is added to the starting product and/or, in order to reduce the expansion of the H₂, the crushed homogenized starting product is introduced into the heat treatment apparatus in a pressure-resistant dimensionally stable container, wherein the increase in volume of the starting product during the treatment in the heat treatment apparatus is limited.

In particular, when natural olivine is used, then pore formation and volume enlargement occur during treatment in the heat treatment apparatus. It is assumed that due to Fe₂SiO₄, which is present in natural olivine, the following reaction also takes place during treatment in the heat treatment apparatus, parallel to the reaction described above.

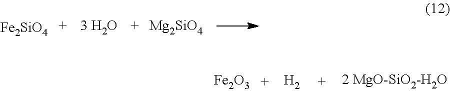

Here, the hydrogen produced is present in a gaseous state after the reaction. The formation of the gas creates the porosity or volume increase and pore formation in the building material to be produced. Although the presence of gas is also known from the production of aerated concrete, however, the formation of the gas there takes place before the hardening process, unlike in the here present case, where the release of gas occurs continuously throughout the entire process and thus reduces the strength.

To prevent this, the formation of H₂ is reduced and/or the expansion of the H₂ is reduced. In the context of the invention, reduction can also be understood as such a strong reduction to the point of prevention. A reduction of the possible expansion can also be understood up to a total prevention of the expansion.

The formation, outgassing or expansion of H₂ can be prevented or reduced by means of various measures. On the one hand, chemical measures can be used. On the other hand, physical measures can also be used. A combination of several measures is also possible.

Chemical measures prevent the formation of H₂ or bind it once it has formed. For example, the forsterite source can be pre-treated by firing it. During the firing process, however, a partial conversion of the forsterite into enstatite (MgSiO₃) also takes place. However, unlike forsterite, enstatite is not able to react with SiO₂ and water to form magnesium silicate hydrate. Therefore, optional corrective substances can be added, for example in the form of CaO sources, which in turn suppress the formation of enstatite.

Alternatively, an oxidizing agent such as MnO₂ can be provided during the treatment in the heat treatment apparatus, which can be added, for example, during the preparation of the starting product. This measure can also prevent the formation of hydrogen gas.

One physical option is to place the starting product in a pressure-resistant, dimensionally stable, in particular closed, container in the heat treatment apparatus, such as an autoclave, with the aim of limiting the increase in volume of the starting product during treatment in the heat treatment apparatus. For example, the container can be completely filled for this purpose. Another embodiment is although not to close the container, but to counteract the expansion by means of external pressure, for example weights on an upper closure or a plate on the container. In principle, it is also possible to increase the pressure within the heat treatment apparatus, preferably within an autoclave, in order to achieve the objective. In this case, expansion of the hydrogen gas is prevented by the pressure-tight container or the external pressure, and thus also reducing outgassing. It is also possible to combine two or all three of these methods.

It is also possible to avoid iron oxidation or other reactions that damage the structure by taking certain technological measures during binder production, for example by thermal treatment in an oxidizing atmosphere, such as firing in a normal atmosphere.

In principle, the starting product can be selected free of SiO₂ sources. Here, in the context of the invention, SiO₂-source-free can be understood to mean that less than 2%, in particular less than 1% and preferably less than 0.5% of an SiO₂ source is provided in the starting product.

Alternatively, the starting product can also have an SiO₂ source, wherein the ratio in percent by mass of forsterite to SiO₂ is from 30%:70% to 85%:15%, wherein additional additives can be added. Additional, partly inert, additives can also be added, for example could this be extenders such as limestone powder, corundum, sand, plastics, waste materials such as ash and slag or metal reinforcement.

It is preferable if amorphous and/or crystalline SiO₂ in pure and/or impure form is used as the SiO₂ source. Accordingly, quartz, tridymite and/or cristobalite, for example, can be added as the SiO₂ source. Contaminated silicon carriers include, among others: thermally treated clays, pozzolans, cement, granulated blast furnace slag, steel mill slag, carbonated cement paste from concrete recycling, feldspars, glass, in particular waste glass, and other silicate materials with an SiO₂ concentration of over 10%, preferably 30%, more advantageously over 50%. The presence of a SiO₂ source increases the compressive strength in the initial stage by allowing the reaction (2) to proceed.

It is also possible to add additives that influence and control the reaction. Examples of this are calcium hydroxide, nucleating agents and organic additives. Here, low concentrations are often sufficient. Nucleating agents accelerate the reaction progress and organic additives such as superplasticizers can reduce the water requirement and thus improve the porosity and strength of the hardened material.

Alternatively or optionally, the ratio at the molar level between forsterite and SiO₂ can be greater than 1:1 in ration on the forsterite side. The two reactions described under (1) and (2) take place in competition with each other, with reaction (2) taking place preferentially. In order to ensure that reaction (1) also or above all takes place, it is advantageous to provide SiO₂ in an undersupply, i.e. less than is necessary for reaction (2) to take place purely.

In order to accelerate the reactions taking place, it may be intended to add one or more additives to the starting product which have a source of NaOH, KOH, NaCl and/or KCl and/or that one or more treatments are carried out before or during the treatment in the heat treatment apparatus to accelerate the reaction taking place. This may, for example, involve crushing during treatment in the heat treatment apparatus, addition of nucleating agents to raise the pH in the heat treatment apparatus, foreign ions or auxiliary substances in the heat treatment apparatus, agitation of the crushed homogenized starting product and/or ultrasonic treatment of the crushed homogenized starting product in the heat treatment apparatus. These or other acceleration treatments can be carried out separately, but also in any combination with each other.

Water glass, for example, can be used as an additive. Water glass includes among other things glassy, i.e. amorphous, water-soluble sodium, potassium and lithium silicates solidified from a melt, as well as their aqueous solutions. Depending on whether they predominantly contain sodium, potassium or lithium silicates, they are also referred to as sodium silicate of soda, potassium silicate of soda or lithium silicate of soda. These additives serve as accelerators of the reactions that take place, wherein a higher compressive strength can be achieved with the same reaction times.

Another possibility is to crush or break up the homogenized starting product continuously or discontinuously, in particular to grind it very finely, during the thermal treatment or between several thermal treatments in the heat treatment apparatus in order to accelerate the conversion. A thermal treatment within the meaning of the invention can also be referred to as hydro-thermal treatment since water is available as a reaction partner during the thermal treatment.

Continuous or discontinuous crushing can prevent or reduce clumping or coalescence of the substances present during hydrothermal treatment. This ensures that there is still present a sufficiently large surface area for the processes described above to take place. Several options are available for exact implementation.

On the one hand, it is possible to interrupt the hydro-thermal treatment, convey the material out of the heat treatment apparatus and crush or break it up, for example grind it, and feed it back again into the heat treatment apparatus.

On the other hand, it is also possible to provide a corresponding crushing system in the heat treatment apparatus, which performs crushing continuously or discontinuously during the hydrothermal treatment.

Another option is to operate a heat treatment apparatus, in particular continuously, and to discharge some of the material from the heat treatment apparatus during the hydrothermal treatment, crush it and feed it back once again into the device. This is particularly useful if the starting product is present in a suspension in the heat treatment apparatus or at least in a pumpable form. In this case, for example, a line can be provided from an autoclave that leads to a crushing device such as a mill and back again into the autoclave, which is an example of a heat treatment apparatus within the meaning of the invention. This can be referred to as a circulation process without interruption. In particular, a renewed wet grinding is useful.

Another option is to add nucleating agents, agents to raise the pH value, foreign ions and/or other additives to the starting product already at the beginning, before or during homogenization or after homogenization or only in the heat treatment apparatus to accelerate the sequence of the reactions.

For example, brucite, lizardite, antigorite, pre-hydrated olivine-containing rock or mixtures of these substances can be added as nucleating agents. The addition of at least 2 percent by mass of nucleating agents is preferred.

Substances that release NaOH, KOH, NaCl, KCl, Na₂SO₄, MgSO₄, K₂SO₄, Na₂CO₃, Ca(OH)₂ and/or K₂CO₃ after their addition can be added as agents for raising the pH-value that modify in this way a solution in which the reaction takes place, whereby increasing the pH-value in the solution so that the reaction proceeds more quickly.

Other additives that also accelerate the reaction include, for example, magnesite, hydromagnesite, nesquehonite, dolomite, SiO₂, feldspars, pyroxenes and mixtures thereof, wherein the addition of these substances can lead to the formation of new reaction products. Examples of foreign ions are aluminum, sulfate or alkalis. Here too, new reaction products can be formed.

In order to increase the purity of the resulting product for CO₂ sequestration, these auxiliary materials can be at least partially removed again after the sequence of the hydrothermal treatment. In principle, the sequence of the reaction can also be carried out by increasing the temperature.

In principle, the reaction process can also be realized by increasing the temperature. In particular, temperatures above 150° C., preferably above 200° C. and more preferably above 250° C. are possible.

An additional way to accelerate the reaction is if the homogenized starting product is present in a suspension for hydro-thermal treatment of the homogenized starting product in the heat treatment apparatus, which is stirred continuously or discontinuously during the hydro-thermal treatment. For example, an agitator can be provided here, which ensures movement of the suspension.

In this context, grinding can also be provided alternatively or additionally—as described above. Wet grinding is particularly suitable here, as part of the suspension can be transported out of the heat treatment apparatus, wet ground and added back again into it. However, this wet grinding can also be carried out directly in the heat treatment apparatus.

Another alternative is ultrasonic treatment of the homogenized starting product. Here, in a similar way to crushing, this ensures that substances formed on the starting product, such as magnesium hydroxide and/or magnesium silicate hydrate, separate from the remaining substances of the starting product so that in turn, a sufficiently large surface area is available to allow the reaction to proceed quickly. This can be done, for example, using an ultrasonic horn or similar.

Depending on the desired further treatment and processing of the homogenized and converted starting product, it may be useful to carry out drying to remove unbound water before the dewatering step, i.e. the separation of bound water. This is particularly indicated and useful then if the hydro-thermal treatment of the starting product was carried out in an aqueous suspension.

The starting product can have any fineness. However, it is preferable if it has a surface area in accordance with BET of 0.03 m²/g or is crushed to this. However, it is advantageously even finer and has, for example, a surface in accordance with BET of 0.1 m²/g, preferably 0.5 m²/g, even better 2 m²/g.

The finer the starting product itself is, the faster and more complete the reactions described above will be. Wet grinding in particular allows the desired fineness to be achieved with low energy consumption. The combination with wet grinding allows the reactions to take place more quickly overall, which in turn makes the overall process much more economical.

Furthermore, it is preferred if sand and/or gravel is added to the starting product, the crushed and/or homogenized starting product with sand or gravel is placed in a mold and treated in this mold in the heat treatment apparatus and the resulting product is used as a solidified building material, in particular as a prefabricated building component.

The resulting product can be used as a solidified building material, in particular as a prefabricated building component. Reinforcement or other materials can also be added, depending on the intended use. In other words, the starting product is used in a similar way to cement, wherein the addition of sand and/or gravel can produce a concrete-like product that has similar properties and can also be used in a similar way.

The converted and dehydrated starting product can be used as a binder, for example as a complete or partial cement substitute, for concrete production before the CO₂ is bound. Here, the water/binder ratio is preferably in the range of 1:2 or less. This means that the ratio is 1:2.22, preferably 1:2.5 and ideally 1:2.86 and even better 1:3.33 or less. It has been found that a higher ratio, i.e. a higher proportion of water, prolongs hardening process and reduces strength. The concrete produced in this way already binds CO₂ from the ambient air at room air and room temperature. In principle, the binding process can be accelerated by heat or pressure treatment.

In an alternative embodiment, the converted, dehydrated and CO₂-bound starting product can preferably be or be solidified and fed as aggregate or filler for the production of concrete and/or mortar. After the CO₂ has been bound, it can be dried again. However, this is not absolutely necessary, as a solid is already formed from the converted and dehydrated starting product when the CO₂ is bound or the strength of the hardened material continues to increase.

The resulting material is inert and is suitable for further processing into concrete together with a hydraulic binder, such as cement clinker. Further crushing may be necessary for this. In principle, it is advantageous for the sequence of the method according to the invention if at least the starting product is free of cement clinker. In particular, this can mean that it has no or hardly any (less than 0.1 percent by mass) alite and/or belite phases. According to experience, the materials present in the cement clinker partially slow down the reactions explained here, so that their presence is not desirable. In small quantities, however, cement clinker is harmless.

Optionally, other substances can be added for mixing that improve the reactivity or modify the properties of the hardened material. These substances include organic additives, in particular superplasticizers, rock flours, in particular limestone, dolomite and olivine, pozzolanic additives such as trass, glass powder, hard coal fly ash and/or thermally activated clays.

The starting products provided according to the invention are usually not pure substances, so that impurities are present to a high degree. However, it is advantageous if at least the molar ratio of Mg to Ca is 10:1 or greater and/or the molar ratio of Si to Al is also 10:1 or greater. It has been shown that the presence of calcium and aluminum each in relation to magnesium and silicon respectively slows down the reactions or in some cases brings them to a complete standstill. It is therefore not insignificant to shift the corresponding molar ratios significantly in the direction of magnesium or silicon. Preferably, the molar ratio of Mg to Ca is at least 20:1 and/or the molar ratio of Si to Al is at least 20:1.

In principle, the invention relates to wet grinding of binders that do not react at room temperature, in particular cements. For this purpose, a binder based on MgO is considered in more detail and proposed. This can also be used for sequestering CO₂. On the one hand, the invention relates such to a binder which, without a dewatering step, binds CO₂ and solidifies in accordance with reactions (6) and (7). On the other hand, the invention also relates to a binder which includes a dewatering step after thermal treatment, wherein reactions (3), (4) and (5) take place. This binds CO₂ and solidifies in accordance with reactions (8), (9), (10) and (11). The invention also relates to prefabricated building components produced with one of the two related binders.

Furthermore, the invention relates to a prefabricated building component which is manufactured according to one of the methods described above.

The method according to the invention can thus be used to produce a prefabricated building component which can be used, for example, analogously to prefabricated building components made of concrete, as a ceramic product, bricks or other building products.

According to the invention, it is possible to produce a building material with significantly less energy input, which can be used as an alternative to Portland clinker-based cements.

1-15. (canceled)

16. A method for preparing a starting product for the manufacture of a concrete-like product,
wherein the starting product is crushed and homogenized before it is sent for further treatment,
wherein the crushing and homogenization takes place during wet grinding,
wherein a starting product is selected which comprises at least 20% by mass of one or more of the following components:
ultramafic rocks, in particular dunite,
weathering products of ultramafic rocks, in particular serpentinite,
a forsterite source in the form of a natural or artificial olivine source,
wherein the crushed homogenized starting product is treated in a heat treatment apparatus at a temperature of more than 30° C. for at least two hours,
wherein water is added to the starting product before, after or simultaneously with the crushing and homogenizing and this is mixed with the starting product, and/or steam is introduced into the heat treatment apparatus,
wherein the crushed homogenized starting product is subjected to dewatering of bound water by means of thermal treatment and/or reaction grinding after treatment in the heat treatment apparatus,
wherein the converted starting product is treated at a temperature between 180° C. and 1000° C. during thermal treatment,
wherein a re-arrangement of the crystal structures in the converted starting product occurs during reaction grinding,
wherein sand and/or gravel are added, and
is/are placed in a mold and is/are heat-treated.

17. The method according to claim 16,
wherein
the starting product is mixed with a liquid, in particular water, and ground as a suspension.

18. The method according to claim 17,
wherein
the suspension with the crushed and homogenized feed product is fed to further treatment by means of hydraulic transport.

19. The method according to claim 16,
wherein
the crushed homogenized starting product is treated at more than 100° C. and/or less than 120° C.

20. The method according to claim 16,
wherein
the crushed homogenized starting product is treated in the heat treatment apparatus at a temperature of more than 150° C., at over 5 bar and/or for at least over 12 hours.

21. The method according to claim 16,
wherein
a CO₂ source and/or carbonate source is present in the heat treatment apparatus or the crushed homogenized, heat-treated starting product is brought into contact with a CO₂ source after the heat treatment apparatus.

22. The method according to claim 16,
wherein
the starting product comprises Fe in reduced form, such as Fe₂SiO₄,
a formation of H₂ is reduced and/or an expansion of the H₂ is reduced,
in order to reduce the formation of H₂, the forsterite source is fired with prior optional addition of correcting agents and/or an oxidizing agent is added to the starting product and/or,
in order to reduce the expansion of the H₂, the crushed homogenized starting product is introduced into the heat treatment apparatus in a pressure-resistant dimensionally-stable container, wherein the increase in volume of the starting product during treatment in the heat treatment apparatus is limited.

23. The method according to claim 16,
wherein
the starting product additionally comprises an SiO₂ source, and
the ratio in % by mass of forsterite to SiO₂ is from 30%:70% to 85%:15%,
wherein additional additives can be added.

24. The method according to claim 16,
wherein
the starting product additionally comprises a SiO₂ source, and
the ratio at the molar level between forsterite and SiO₂ is in the ratio of over 1:1 on the side of forsterite.

25. The method according to claim 16,
wherein
one or more additives are added to the starting product which have a source for NaOH, KOH, NaCl and/or KCl and/or
before or during the treatment in the heat treatment apparatus, one or more treatments to accelerate the reactions taking place, such as crushing during treatment in the heat treatment facility,
addition of nucleating agents, agents to raise the pH value, foreign ions and/or additives,
moving the crushed homogenized starting product in the heat treatment apparatus,
ultrasonic treatment of the crushed homogenized starting product in the heat treatment apparatus,
are carried out.

26. The method according to claim 16,
wherein
the starting product is crushed to a surface area in accordance with BET of at least 0.03 m²/g.

27. A prefabricated building component,
wherein
it is manufactured by a method according to claim 16.
